(19) United States
(12) Patent Application Publication
(10) Pub. No.: US 2015/0102180 A1
(43) Pub. Date: Apr. 16, 2015

(54) Post Support

(71) Applicant: Gregory Paul Boland, Southgate, MI (US)

(72) Inventor: Gregory Paul Boland, Southgate, MI (US)

(21) Appl. No.: 14/515,621

(22) Filed: Oct. 16, 2014

Related U.S. Application Data
(60) Provisional application No. 61/891,700, filed on Oct. 16, 2013.

(51) Int. Cl. E04H 12/22; F16L 3/10; H02G 3/22; E04C 2/40

(52) U.S. Cl. CPC E04H 12/22; E04C 2/40; F16L 3/1091; H02G 3/22
USPC 248/67.5

(57) ABSTRACT

A bracket including a foundation portion and a post leg portion. The post leg portion may include a plurality of tabs for engaging a strap member. The strap member is configured to engage and support a post member.

### RELATED APPLICATION

This U.S. patent application claims priority to U.S. Provisional Application 61/891,700 filed on Oct. 16, 2013.

### BACKGROUND OF THE INVENTION

The present invention relates to a post support and, more particularly, to such supports used on protective pipes where overhead power and telephone wires enter a structure.

Currently, if a user would like to support a, for example, an electrical service mast where overhead power and telephone wires enter a structure they must use a single-piece support, which tend to be inflexible and so regularly break during installation or while providing support due to strain on the element of the support that holds the post. Additionally, because installation of the single-piece supports typically demands removal of the “weather head”—the weatherproof cap at the entry point of such wires - disconnection and reconnection of the services provided by the wire is also a problem.

As can be seen, there is a need for a two-piece, flexible post support.

### BRIEF DESCRIPTION OF THE DRAWINGS

FIGS. 1A to 1E shows various views of a bracket of an embodiment of the present invention;

FIGS. 2A to 2C show various views of a strap of an embodiment of the present invention; and

FIG. 3 is an exemplary embodiment of the present invention installed on a roof.

FIGS. 4A to 4E show various views of an alternative embodiment of a bracket of the present invention that incorporates a hinge.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a post support device, system and method. The post support may include a bracket and a strap. The user may adapt the bracket to mount a post thereon and then attach the bracket to a foundation or other rigid support and separately may couple the strap to the bracket with the post securely sandwiched in between.

In certain embodiments, the user may adapt the strap to mount a post thereon and then couple the strap to the bracket with the post securely sandwiched in between, and then may attach the bracket to the foundation.

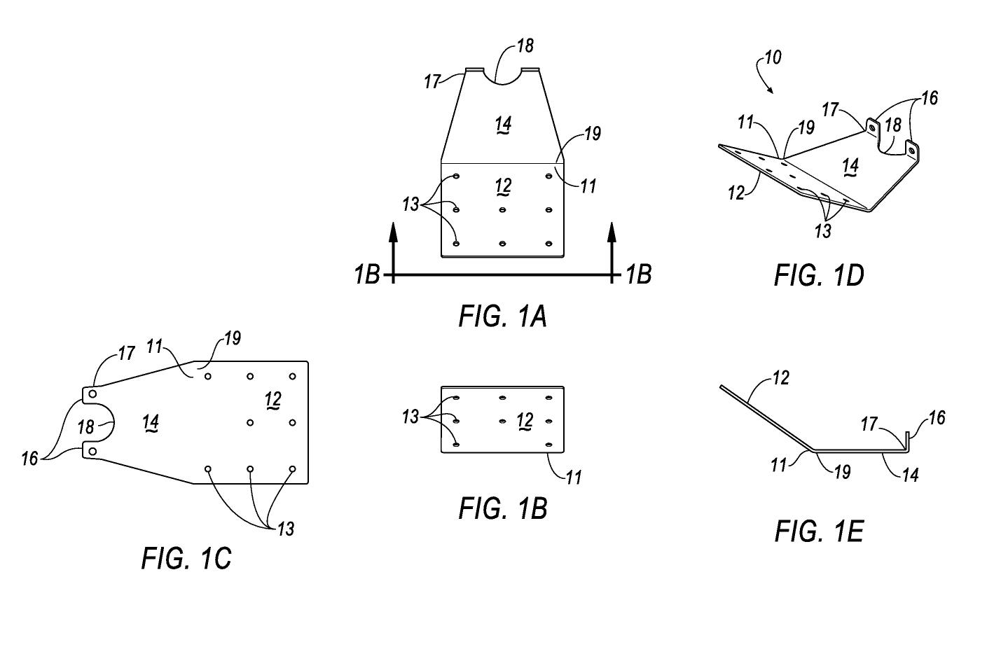

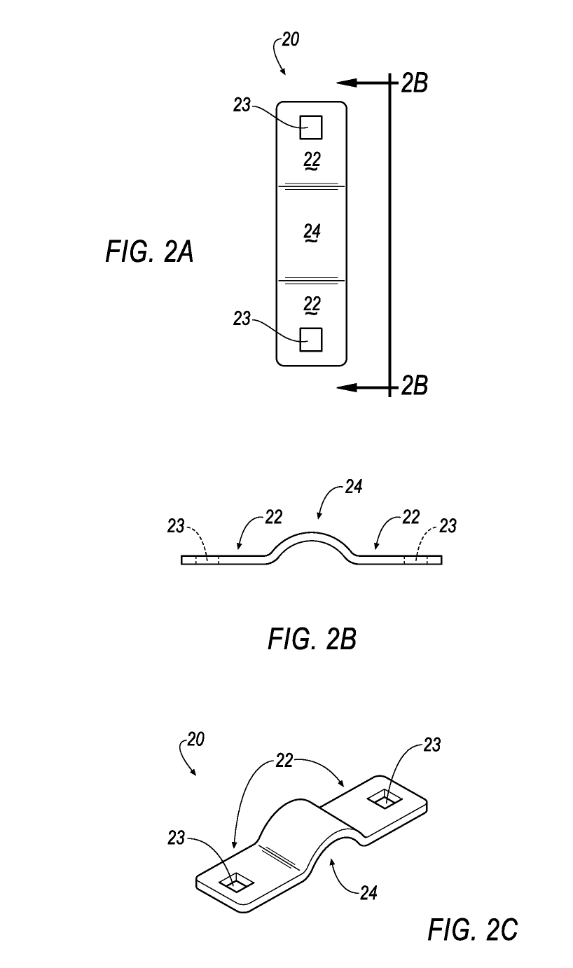

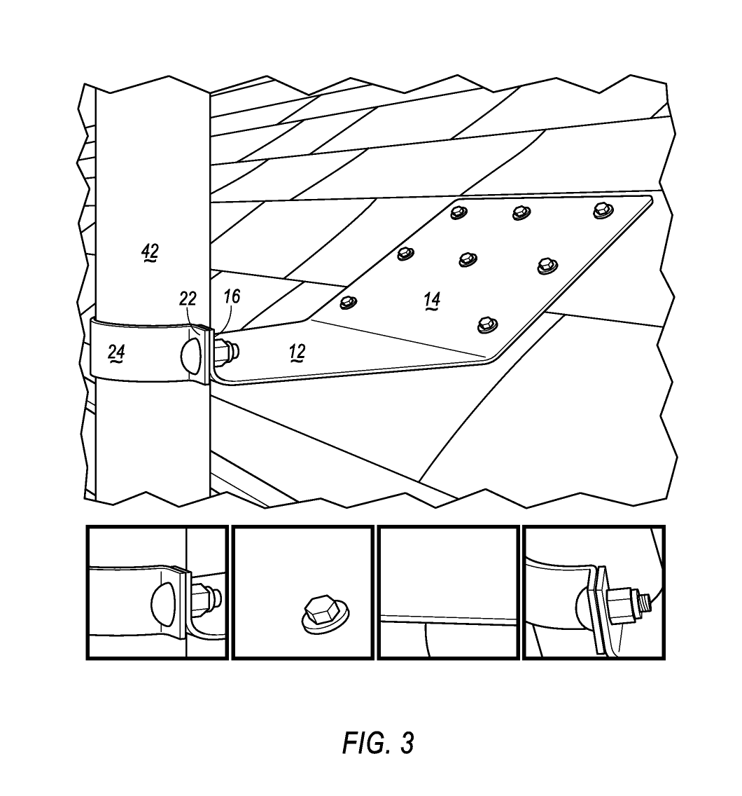

Referring now to FIGS. 1 through 4, the present invention may include a post support 40 that includes a bracket 10 (FIG. 1D) and strap 20 (FIG. 2C). The bracket 10 may include a foundation leg 12 having a first end 11 connected to a post leg 14 having a first end 19 and a second end 17. The second end 17 may include a plurality of tabs 16 and a notch 18. The strap 20 may include a plurality of arms 22 connected to opposite ends of a collar 24. The bracket 10 and the strap 20 may be connected by attaching the plurality of strap arms 22 to the plurality of tabs 16 sandwiching the post 42 between the notch 18 and the collar 24. The foundation leg 12 may be attached to a rigid support, like a roof, wall, or other structural element.

In certain embodiments, the notch 18 and collar 24 may be shaped to at least partially conform to an outer contour differently shaped pipe or post, for example, but not limited to, circular, square, oval, and the like. In certain embodiments, the tab 16 may include a tab opening 15, the arm 22 may include a strap opening 23, and the foundation leg 12 may include a plurality of foundation leg openings 13. Openings 15, 23 may be used to accommodate the passage of a fastener. In alternate embodiments, the arm 22 may be connected to the tab 16 by an attachment device that, for example, passes through both the strap opening 23 and tab opening 15. In other embodiments, the foundation leg 12 may be connected to the foundation by an attachment device passing through the foundation leg openings 13 to the foundation.

In certain embodiments, the present invention may be comprised of a flexible sheet of weatherproof material such as metal, metal composites, plastic, plastic composites, resin impregnated carbon fiber material, etc. that may be repeatedly used without fracturing.

In certain embodiments, the angle “A” between the foundation leg 12 and the post leg 14 may be less than approximately 180 degrees to facilitate the method of using the present invention.

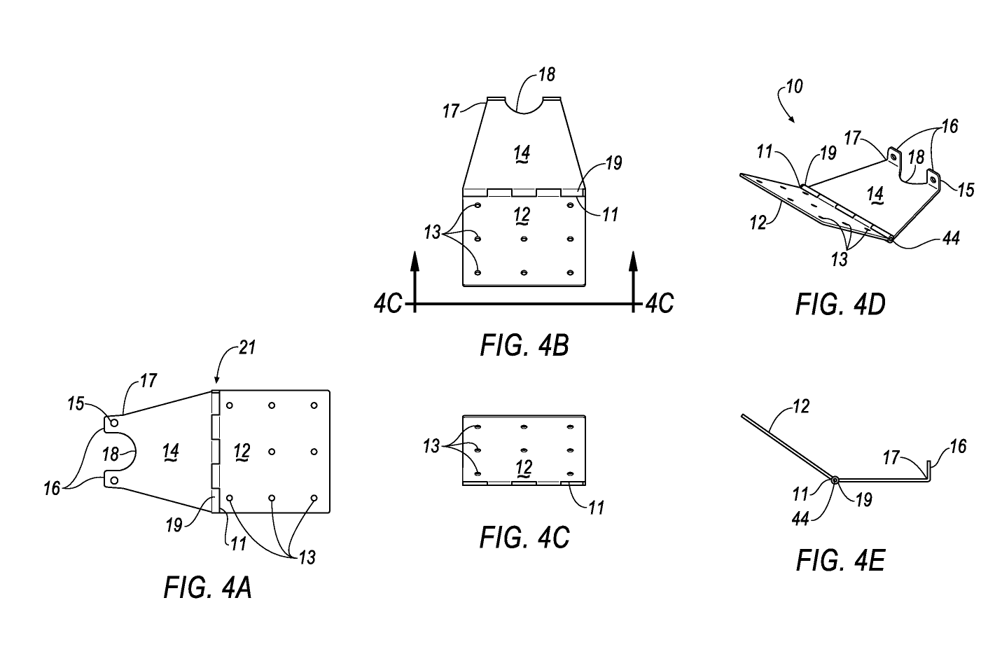

In an embodiment depicted in FIGS. 4A through 4E, first leg 19 of post leg 14 may be joined to first end 11 of foundation leg 12 by way of an articulating member 21, such as an articulating hinge member (see FIGS. 4A through 4E). Articulating member 21 may be fabricated in the style of a barrel hinge. In an embodiment, the hollow cylindrical shaped portions of the barrel hinge may be at least in part formed from at least a portion of the first leg 19 of the post leg 14, or the first end 11 of the foundation leg 12, or both.

In an embodiment, the hollow cylindrical portion of at least a portion of the barrel hinge is formed by rolling at least an end portion of at least one of the first leg 19 or the first end 11 to form the hollow cylindrical portion that is adapted to accept pivot pin 44.

A method of using the present invention may include the following. The post support 40 disclosed above may be provided. A user may adapt the post support 40 so to sandwich the post 42 between the collar 24 and the notch 18. The user may then connect the arms 22 to the tabs 16. The user may then attach the foundation leg 12 to the foundation or other rigid support. Alternatively, the user may first attach the foundation leg 12 to the foundation, then sandwich the post between the notch 18 and the collar 24, and then connect the arms 22 to the tabs 16.

In certain embodiments of the two-piece post support (10, 20), the user may keep the weather head intact when installing and using the post support 40 since the support need not be lowered down over the post, unlike currently used single-piece post supports.

It should be understood, of course, that the foregoing relates to exemplary embodiments of the invention and that modifications may be made without departing from the spirit and scope of the invention as set forth in the following claims.

What is claimed is:

1. A post support comprising:
a bracket comprising;
a foundation leg 12 having a first end; and
a post leg 14 having a first end 19 and a second end 17, wherein the second end 17 comprises a notch 18 and a plurality of tabs 16, wherein the first end 19 of the post leg 14 attaches to the first end 11 of the foundation leg 12; and
a strap 20 comprising;
a collar 24; and
a plurality of arms 22 removably attached to the plurality of tabs 16, wherein the notch and the collar are adapted to sandwich a post 42 therebetween.

2. The post support of claim 1, further including an articulating member connected between the first end of the post leg and the first end of the foundation leg.

3. The post support of claim 1, wherein at least a portion of the collar 24 is shaped to at least partially conform to a portion of an outer contour of post 42 that is circular in cross-section.

4. The post support of claim 1, wherein the first end 19 of the post leg 14 attaches to the first end 11 of the foundation leg at an angle that is less than 180° degrees.

5. The post support of claim 4, wherein first leg 19 of post leg 14 is joined to first end 11 of foundation leg 12 by way of an articulating member 21.

6. The post support of claim 5, wherein the articulating member is a barrel hinge.

7. The post support of claim 6, wherein the barrel hinge includes one or more hollow, cylindrical portions.

8. The post support of claim 7, wherein the hollow, cylindrical portions of the barrel hinge are formed, at least in part, from at least a portion of the first leg 19 of the post leg 14 or the first end 11 of the foundation leg 12.

9. The post support of claim 8 wherein a portion of the first leg 19 or the first end 11 are rolled to form the cylindrical portion of the barrel hinge.

10. The post support of claim 9, wherein the cylindrical portion of the barrel hinge has a cylindrical opening that is adapted to accept a pivot pin 44.
